(19) United States
(12) Patent Application Publication
(10) Pub. No.: US 2009/0247197 A1
(43) Pub. Date: Oct. 1, 2009

(54) CREATING ONLINE RESOURCES USING INFORMATION EXCHANGED BETWEEN PAIRED WIRELESS DEVICES

(75) Inventors: Bruno Y. Graff, La Rochelle (FR); Christian Pineau, Los Gatos, CA (US); Luc BeAl, Villars les Dombes (FR); Johann J. C. Graff, La Rochelle (FR); Sylvain P. A. Doyen, Le Mans (FR)

Correspondence Address: FISH & RICHARDSON P.C., PO BOX 1022, MINNEAPOLIS, MN, 55440-1022, US

(73) Assignee: Logincube S.A.

(21) Appl. No.: 12/412,213

(22) Filed: Mar. 26, 2009

Related U.S. Application Data
(60) Provisional application No. 61/040,124, filed on Mar. 27, 2008.

(51) Int. Cl. H04W 4/12

(52) U.S. Cl. 455/466

(57) ABSTRACT

A database of family, friends and professional network relationships are established through the exchange of unique identifiers between paired mobile devices using wireless technology. The paired mobile devices exchange information related to the users' identities. The mobile device users can independently upload the exchanged information through one or more access points to an online service. The online service uses the uploaded information to create online resources for the users.

### RELATED APPLICATIONS

This application claims the benefit of U.S. Provisional Patent Application No., 61/040,124, filed Mar. 27, 2008, which provisional patent application is incorporated by reference herein in its entirety.

This application is related to U.S. patent application Ser. No. 12/298,030, for “Monitoring For the Presence of a Radio-Communicating Module in the Vicinity A Radio-Communicating Terminal,” filed Oct. 21, 2008, which U.S. patent application is incorporated by reference herein in its entirety.

### TECHNICAL FIELD

This subject matter is generally related to data communications between electronic devices.

### BACKGROUND

Social network services focus on building online communities of people who share interests and/or activities, or who are interested in exploring the interests and activities of others. Most social network services are web based and provide a variety of ways for users to interact, such as e-mail and instant messaging services. Social networking has created new ways to communicate and share information. Some popular social networking services include directories of categories (e.g., former classmates), means to connect with friends (e.g., with self-description pages), and recommender systems linked to trust. Some popular social networking sites include MySpace™ and Facebook™.

Social networking services allow users to create a profile for themselves and share their profiles with other subscribers of the services. An online social network can be a closed or private community that consists of a group of people within a company, association, society, education provider and organization or even an “invite only” group created by a user in the community. Some services allow users to upload a picture of themselves, create a profile and be “friends” with other users. In most social networking services, both users must confirm that they are friends before they are linked. For example, if Alice lists Bob as a friend, then Bob would have to approve Alice's friend request before they are listed as friends. Some social networking sites have a “favorites” feature that does not need approval from the other user. Social networks usually have privacy controls that allows the user to choose who can view their profile or contact them, etc. Some social networks have additional features, such as the ability to create groups that share common interests or affiliations, upload or stream live videos, and hold discussions in forums.

Lately, mobile social networking has become popular. In most mobile communities, mobile phone users can now create their own profiles, make friends, participate in chat rooms, create chat rooms, hold private conversations, share photos and videos, and share blogs by using their mobile phone. Such features, however, require the user to access a website and to manually create groups that share common interests or affiliations.

### SUMMARY

A database of family, friends and professional network relationships are established through the exchange of unique identifiers between paired mobile devices using wireless technology. The paired mobile devices exchange information related to the users' identities. The mobile device users can independently upload the exchanged information through one or more access points to an online service. The online service uses the uploaded information to create online resources for the users.

### DESCRIPTION OF DRAWINGS

FIG. 1 illustrates an example system for creating online resources using data exchanged between paired wireless devices.

FIG. 2 is a flow diagram of an example process performed by a wireless device for collecting and uploading data exchanged with another wireless device to an online resource.

FIG. 3 is an event diagram illustrating an example message communication between paired wireless devices.

FIG. 4 is an event diagram illustrating an example message communication between a mobile device and an access point

FIG. 5 is a block diagram illustrating an example terminal/device architecture.

FIG. 6 is a block diagram illustrating an example architecture for an online service.

### DETAILED DESCRIPTION

### System Overview

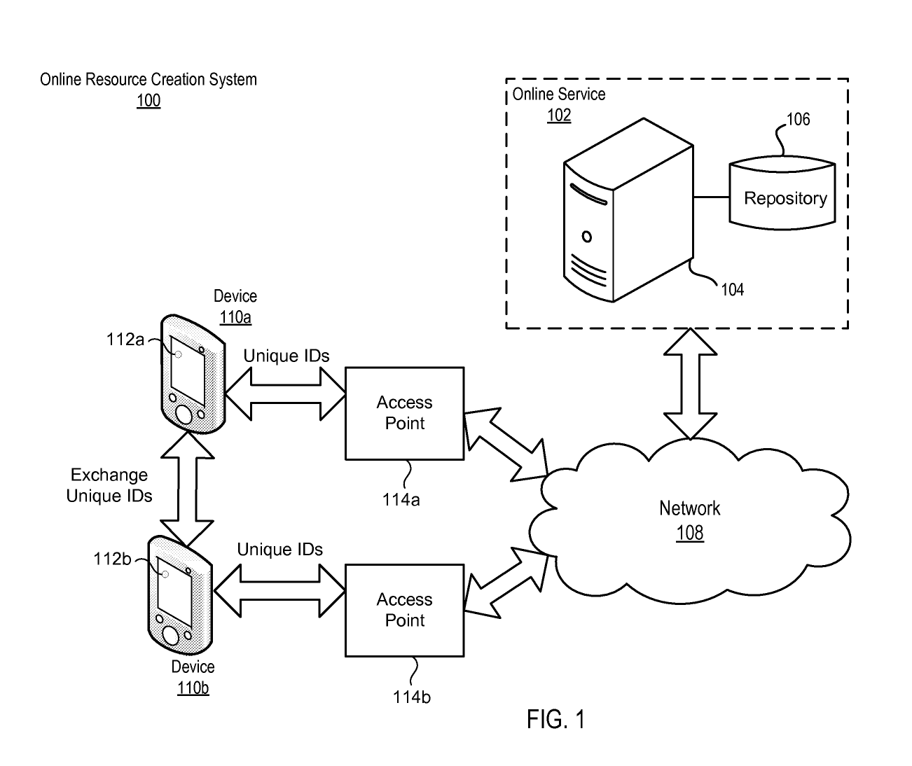

FIG. 1 illustrates an example system for creating online resources using data exchanged between paired wireless devices. In some implementations, an online resource creation system 100 can include an online service 102, mobile devices 110 and access points 114. The access points 114 (e.g., a Wi-Fi base station, cell tower, host computer, hub, router) are operable for connecting the mobile devices 110 to a network 108 (e.g., the Internet) using Wi-Fi, WiMAX, Bluetooth or related standards. The access points 114 can connect to a wired network, and can relay data between the mobile devices 110 and wired devices (e.g., server computer 104) coupled to the network 108. The online service 102 can include one or more server computers 104 and a one or more repositories 106 for storing information (e.g., unique IDs) transmitted by mobile devices 110.

The mobile devices 110 can be any device capable of communicating with other devices through wireless communication links, and that can also transmit information to an online service. Some examples of mobile devices are mobile phones, smart phones, email devices, portable computers, ebook readers, digital cameras, video cameras, media players, etc. The mobile devices 110 can include a wireless subsystem for enabling wireless communication with an access point 114. The wireless communication can be supported by one or more wireless protocols, such as Wi-Fi, Bluetooth, WiMAX, etc. Communication between the access points 114 and the network 108 can be supported by one or more wired or wireless communication protocols (e.g., Internet Protocol, HTTP, TCP/IP, SIP, Wi-Fi, WiMAX, Bluetooth).

In some implementations, when pressing a dedicated button or user interface element on device 110a, an icon or other user interface element 112a is displayed (e.g., blinking icon) on device 110a. The icon 112a indicates that that device 110a is searching for another device, such as device 110b, in this example. If device 110a discovers device 110b, then device 110a attempts to connect to device 110b by sending a request signal to device 110b. Any devices 110 that are in physical proximity to device 110a and are operating in a “discovery mode” can receive the request signal from device 110a. An example communication technology that includes a “discovery mode” is Bluetooth technology which is described in a publicly available Bluetooth specification.

On device 110b (the receiving device), a similar icon or user interface element 112b can be displayed (e.g., also a blinking icon) to indicate that device 110a is requesting communication with device 110b to exchange information with device 110b.

In some implementations, the discovery of devices can include the technology described in co-pending U.S. patent application Ser. No. 12/298,030, for “Monitoring For the Presence of a Radio-Communicating Module in the Vicinity A Radio-Communicating Terminal.”

In some implementations, if the user of device 110b acknowledges the request from device 110a by, for example, pressing a dedicated button or user interface element on device 110b, a data exchange can be initiated between devices 110a and 110b, and information from each device can be stored on the other device. In some implementations, the information can be automatically exchanged as soon as a connection is made between the two devices without further user action. Once the information is exchanged, the devices 110a, 110b can be automatically disconnected. In some implementations, the information can be a unique identifier (ID). Some example unique IDs include but are not limited to a Bluetooth BD address, International Mobil Equipment Identity (IMEI), International Mobile Subscriber Identity (IMSI), Mobile Equipment Identifier (MEID) or any other identifier that can uniquely identify a device or a user.

Independently, and at the same or a later time, and at the same or different location, the users of devices 110a, 110b can upload the exchanged information to a network server 104 operated by an online service 102 through the one or more network access points 114. For example, device 110a can upload the exchanged information to network 108 through access point 114a and device 110b can upload the exchanged information to network 108 through access point 114b. The information can be stored in the repository 106 operated by the online service 102.

In some implementations, the online service 102 can use the uploaded information to create or update personal or professional networks of the users of devices 110a, 110b. For example, the online service 102 can look at unique ID pairs and timestamps, geographic location (if the devices are location-aware) to form an online community (e.g., a social network) or other online resource. Once the network is formed, the users of the devices 110a, 110b can be invited by the online service 102 to join or access the online community or other online resource.

### Example Process

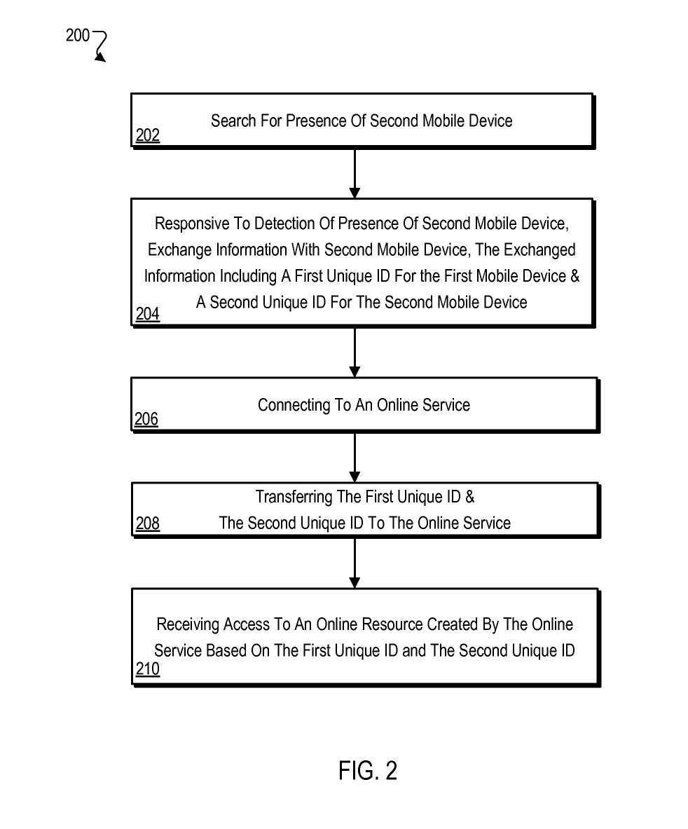

FIG. 2 is a flow diagram of an example process 200 performed by a first mobile device for collecting and uploading data exchanged with a second mobile device to an online service. In some implementations, the process 200 begins when the first mobile device searches for the presence of the second mobile device (202). Responsive to a detection of presence of the second mobile device, the first and second mobile devices exchange information (204), where the exchanged information includes unique IDs of the first and second mobile devices. In some implementations, a unique ID for a mobile device can be a Bluetooth BD address or IMEI.

Independently, and at the same or a later time, and at the same or different locations, the first and second mobile devices connect to an online service (206) and upload the exchanged information to the online service (208). The online service uses the uploaded information to create an online community or other online resource, then sends an invitation or other notification to the mobile devices to join or access the online community or other online resource. The mobile devices receive the invitation to access the online resource created by the online service based on the exchanged information (210), which in one implementation can be the exchanged unique IDs (e.g., IMEI, BD address).

### Example Communication Protocols

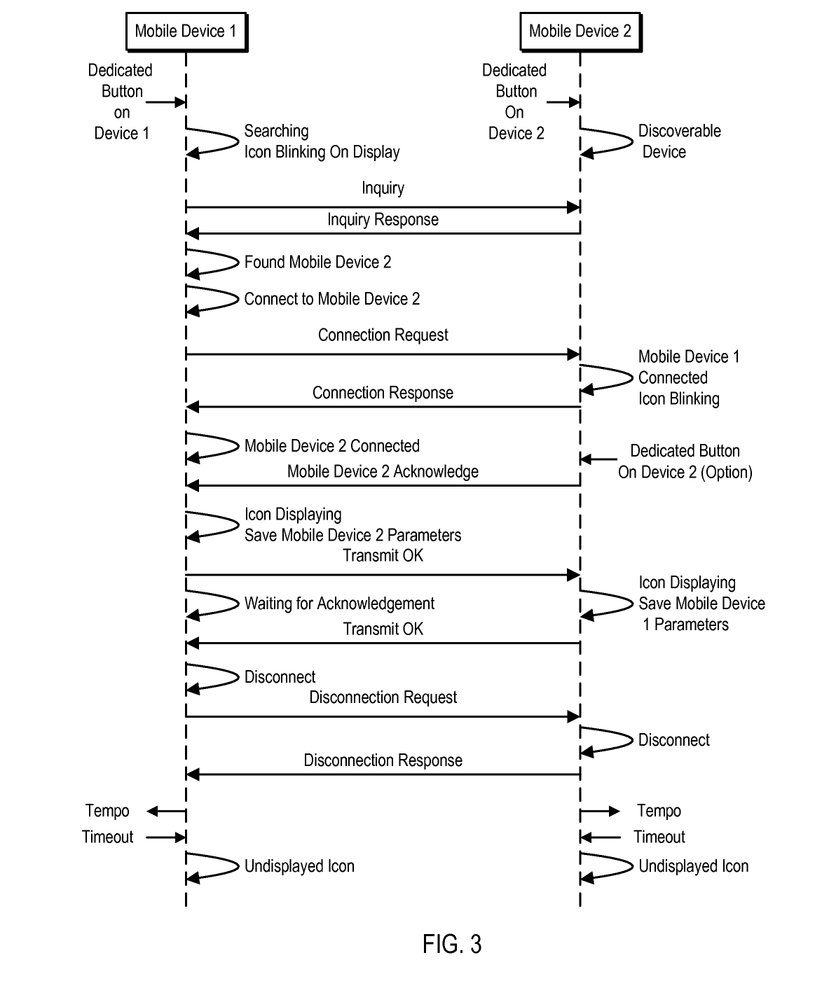

FIG. 3 is an event diagram illustrating an example message communication between paired wireless devices. In this example, the message exchange is between Mobile Device 1 (MD1) and Mobile Device 2 (MD2). The y-axis indicates time which increases as you move from the top of the figure to the bottom of the figure.

The message communication begins when the user of MD1 presses a dedicated button or user interface element on MD1. Responsive to the button being pressed by the user, MD1 begins to search for other devices in physical proximity to MD1. An icon or other user interface element can provide visual or audio feedback to the user of MD1 to indicate that a search is in process.

A device MD2 that is in discovery mode receives an inquiry from MD1 and provides an inquiry response or acknowledgment. When MD2 is discovered by MD1, MD1 connects to MD2 by sending a connection request to MD2. MD2 sends a connection response or acknowledgement. An icon or other user interface element can be displayed on MD2 that provides visual or audio feedback to the user of MD2 to indicate a connection with MD1. Optionally, MD2 can include a dedicated button or user interface element for initiating information exchange with MD1 or for putting MD2 into a discovery state.

Once a connection is established between MD1 and MD2, information (e.g., unique IDs) is exchanged between MD1 and MD2. The exchanged information can be stored in or on a storage device or memory of MD1 and MD2. For example, MD1 and MD2 each can store its own unique ID and the unique IDs of other devices participating in the information exchange. The unique IDs can be paired with a stored timestamp indicating when the information exchange occurred. Geographic location can also be stored and paired with the information exchanged if MD1 or MD2 is a location-aware mobile device (e.g., includes GPS). Once the information is successfully transmitted and stored, MD1 can send a disconnection request which can be acknowledged by MD2.

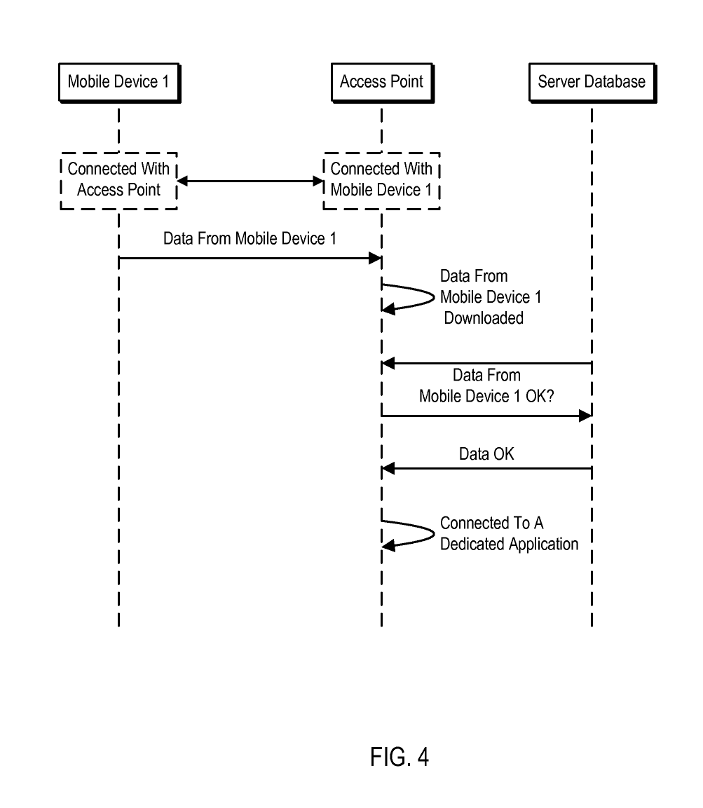

FIG. 4 is an event diagram illustrating an example message communication between a mobile device and an access point. In this scenario, MD1 can be wired (e.g., tethered to a host computer) or wirelessly connected to an access point and uploads information exchanged with MD2 (e.g., unique IDs, geographic location, timestamps) to a server database operated by an online service. The data is checked for errors and used to create an online resource, such as an online community or other online resource.

MD2 can also connect to an access point and perform the same steps as MD1 for uploading information exchanged with MD1. The access points can be the same or different for MD1 and MD2. The access points can be at different geographic locations. The uploading can occur at or about the same time as the information exchange or at a later time. If the uploading occurs at the time of the information exchange, and the geographic location of the access point is known, then that geographic location can be uploaded as the location where the information exchange occurred.

### Example Architectures

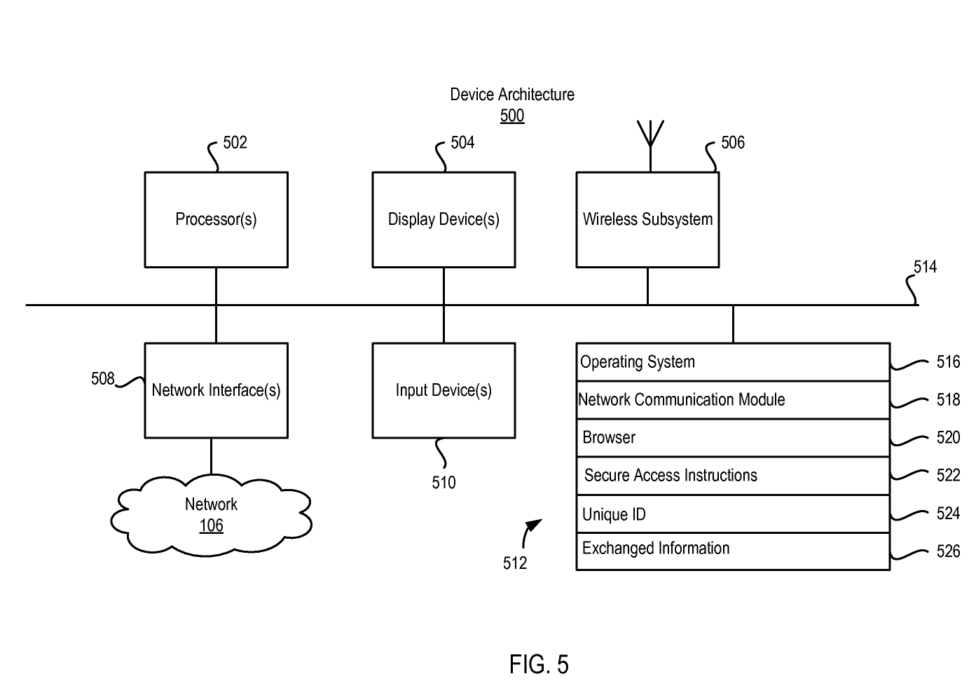

FIG. 5 is a block diagram illustrating an example device architecture for implementing the processes described in reference to FIGS. 1-4. In some implementations, the device is a mobile phone having the architecture 500. The architecture 500 is an example architecture and other architectures are possible, including architectures having more or fewer components.

The architecture 500 generally includes one or more of: processors or processing cores 502 (e.g., Intel Core 2 Duo processors), display devices 504 (e.g., an LCD) and input devices 510 (e.g., mouse, keyboard, touch pad). The architecture 500 can include a wireless subsystem 506 for wireless communications (e.g., a Bluetooth wireless transceiver) and one or more network interfaces 508 (e.g., USB, Firewire, Ethernet) for wired communications. The communication terminal and device include various computer-readable mediums 512, including without limitation volatile and non-volatile memory (e.g., RAM, ROM, flash, hard disks, optical disks). These components exchange data, address and control information over one or more communication channels or busses 514 (e.g., EISA, PCI, PCI Express).

The term “computer-readable medium” refers to any medium that participates in providing instructions to a processor 502 for execution, including without limitation, non-volatile media (e.g., optical or magnetic disks), volatile media (e.g., memory) and transmission media. Transmission media includes, without limitation, coaxial cables, copper wire and fiber optics. Transmission media can also take the form of acoustic, light or radio frequency waves.

The computer-readable medium 512 further includes an operating system 516 (e.g., Mac OS®, Windows®, Linux, etc.), a network communication module 518, a browser 520 (e.g., Microsoft® Internet Explorer, Netscape®, Safari®, etc.) and secure access instructions 522.

The operating system 516 can be multi-user, multiprocessing, multitasking, multithreading, real-time and the like. The operating system 516 performs basic tasks, including but not limited to: recognizing input from input devices 510; sending output to display devices 504; keeping track of files and directories on computer-readable mediums 512 (e.g., memory or a storage device); controlling peripheral devices (e.g., disk drives, printers, network interface 508, etc.); and managing traffic on the one or more buses 514. The network communications module 518 includes various components for establishing and maintaining network connections (e.g., software for implementing communication protocols, such as TCP/IP, HTTP, Ethernet, etc.). The browser 520 enables the user to search a network (e.g., Internet) for information (e.g., digital media items). The secure access instructions 522 enables the features and processes described in reference to FIGS. 1-5. In some implementations, the unique ID 524 is stored on the computer-readable medium 512. The unique ID 524 can be, for example, an IMEI, IMSI, MEID or any other identifier that can uniquely identify a device or a user. Information 526 exchanged with other devices can also be stored in computer-readable medium 512.

In operation, the device can use the wireless subsystem 506 to exchange information with another device, including a unique ID 524. The input device 510 can be a keyboard, touch surface or any other input mechanism that can accept user input. The device can couple to a network 106 through a wired or wireless link.

### Example Online Service Architecture

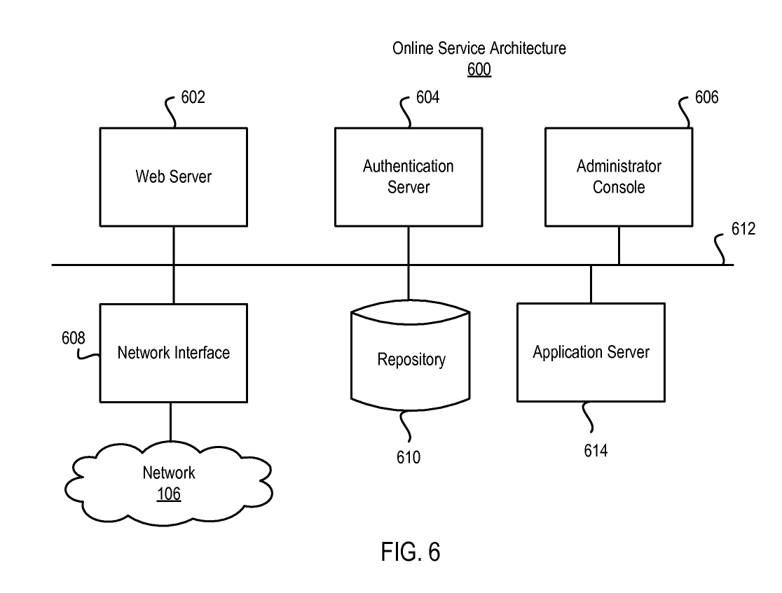

FIG. 6 is a block diagram illustrating an example architecture 600 for an online service (e.g., online service 102). In some implementations, the architecture 600 generally includes a web server 602, an authentication server 604, an optional administrator console 606, a network interface 608, a repository 610 and an application server 614. Each of the these components can be coupled to one or more communication channels or busses 612. The architecture 600 is an example architecture and other architectures are possible, including architectures having more or fewer components.

The web server 602 can serve web pages to the communication terminal 104 as described in reference to FIG. 1. The authentication server 604 can validate unique IDs and authenticate users as described in reference to FIGS. 1-5. The optional administrator console 606 can be used by a website administrator to manage the secure access service. The network interface 608 can be used to interface with network 106 to facilitate communication with communication devices. The repository 610 (e.g., SQL database) can be used to store unique IDs and other information exchanged between devices (e.g., timestamps, geographic location of exchange event). The application server 614 can execute an application that uses the unique IDs and other exchanged information to create online resources.

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method performed by a first mobile device paired with a second mobile device, the method comprising:
searching for the presence of the second mobile device;
responsive to detection of the presence of the second mobile device, exchanging information with the second mobile device, the exchanged information including a first unique identifier for the first mobile device and a second unique identifier for the second mobile device;
connecting to an online service;
transferring the first unique identifier and the second unique identifier to the online service; and
receiving access to an online resource created by the online service based on the first unique identifier and the second unique identifier.

2. The method of claim 1, further comprising:
presenting a user interface element on a display of the first mobile device for indicating the searching.

3. The method of claim 1, where the online resource is an online community of device users who transmit their unique identifiers to the online service.

4. The method of claim 1, where exchanging information automatically occurs when the first mobile device and second mobile device are connected.

5. A computer-implemented method performed by an online service operable for connecting with two or more mobile devices, the method comprising:
receiving a first unique identifier from a first mobile device;
receiving a second unique identifier from a second mobile device;
creating an online resource based on the first unique identifier and the second unique identifier; and
providing access to the online resource to at least one of the first mobile device and the second mobile device.
